(19) United States
(12) Patent Application Publication
(10) Pub. No.: US 2021/0387094 A1
(43) Pub. Date: Dec. 16, 2021

(54) PICTURE MESSAGING GAME

(71) Applicant: PICPLAYCE, LLC, Hillsborough, NJ (US)

(72) Inventors: Jason Bryan Young, Hillsborough, NJ (US); Julian Steven Biebelberg, Edison, NJ (US)

(21) Appl. No.: 17/286,770

(22) PCT Filed: Oct. 17, 2019
(86) PCT No.: PCT/US2019/056745

§ 371 Date: Apr. 19, 2021

Related U.S. Application Data
(60) Provisional application No. 62/748,521, filed on Oct. 21, 2018.

(51) Int. Cl. A63F 13/63; A63F 13/655; A63F 13/71; A63F 13/87; G06F 21/36

(52) U.S. Cl. CPC A63F 13/63; A63F 13/655; A63F 13/71; G06F 2221/2133; G06F 21/36; A63F 2300/638; A63F 13/87

(57) ABSTRACT

A system for playing a picture messaging game includes a game sewer, one or more computing devices, a storage medium, and at least one processor for executing instructions to create and run the picture messaging game. The game includes capturing, modifying, and labelling a captured image via user input, and transmitting a game request or picture puzzle with the modified image to a participating user who attempts to solve the game or picture puzzle under timed conditions or other constraints. The system also allows a user to create a picture puzzle for security purposes, and to use the picture puzzle as a key for entry into one or more of the user's devices, accounts, or websites, or as a form of Captcha for differentiating computers from human users attempting to access a website or website content.

### CROSS-REFERENCE TO RELATED APPLICATIONS

This application claims priority to U.S. Provisional Patent Application No. 62/748,521, filed Oct. 21, 2018 and titled PICTURE MESSAGING GAME, the entire disclosure of which is hereby incorporated by reference herein in its entirety.

### BACKGROUND OF THE INVENTION

### 1. Field of the Invention

The present description relates generally to systems and methods for a picture identification system and methodology for use in, among other things, gaming and cryptographic security.

### 2. Description of the Related Art

Traditional games of skill attract users who seek challenges, particularly when competition and/or prizes are involved. Word games, puzzles, and trivia questions are commonly used in board games, newspapers, and magazines, as well as by radio and television broadcasters, to create buzz, ratings, draw attention to particular subjects, etc. Such games can also bring people together, help forge relationships, and sharpen mental skills. Each participant may desire a promised reward, or may simply aspire to beat a friend, relative, or colleague at a particular game. Other beneficiaries of a game may include the game sponsor, who may wish to promote a particular product or service, as well as other participants who, despite not winning, enjoy playing and building rapport with their fellow competitors. Traditionally, such games were played in person, over the phone, or by mail.

The advent and coupling of the internet, wireless phone networks, web-based technology, social-media, smartphones, and downloadable apps have given rise to new types of remote communication which increase the potential for not only new types of games, but also new ways of playing them. Such new forms of communication include, for example, Short Message Service (SMS) text messaging, Multimedia Messaging Service (MMS) (which sometimes requires internet access, allows for longer text messages, and supports pictures, video, and audio), online chat, snapchat, picture messaging, etc.

While these new forms of communication and technology have made remotely played games a burgeoning field, little if anything has been done in the art with respect to picture messaging in terms of game development other than traditional jigsaw puzzle applications. This lack of development is a significant deficiency in the art, as the old adage that “a picture is worth a thousand words” certainly applies to the modern realm. Moreover, these new technologies and modes of online communication have increased the need for security measures, for storing and communicating personal or confidential information, for differentiating between an actual human user and a computer or bot, and for allowing entry of a user into one or more devices, accounts, or websites.

Indeed, the inventive disclosure of the present application provides a novel picture messaging game system and non-traditional methodologies that facilitate competitive challenges between participants and give rise to various gaming and security applications.

### SUMMARY AND OBJECTS OF THE INVENTION

This summary is not intended to identify or point to essential features or limit the scope of the subject matter claimed herein. The present invention relates to systems and methodologies for picture games and security with at least the following objectives:

To create a personalized picture messaging game, challenge, or puzzle via user interfaces on a sender's mobile device which facilitate capturing and modifying an original image into a modified image, and forwarding the modified image as part of a game, challenge, or puzzle to a participant under timed conditions or other constraints;

To manually split or divide a captured image into image components, rotate, switch, and modify the image components via user interfaces on a mobile device, reassemble the modified image components into a modified image on the mobile device, and send the modified image to a second mobile device of a participant user;

To provide user interfaces on a game participant's mobile device which facilitate receiving a game request with a modified image, manually rearranging the modified image back into what the participant believes is the original image, and communicating the rearranged, purported original image from the participant's mobile device with or without one or more guesses as to the name of the subject of the original image;

To operatively couple a set of mobile devices to a game server and conduct one or more simultaneous picture messaging games between remote game participants, during which the game participants attempt to solve a particular picture messaging game created by a user under timed conditions or other constraints:

To create and utilize a picture puzzle as a form of CAPTCHA (Completely Automated Public Turing test to tell Computers and Humans Apart) for differentiating computers from human users attempting to access a website or website content;

To provide user interfaces which facilitate responding to a CAPTCHA (Completely Automated Public Turing test to tell Computers and Humans Apart) test by manipulating one or more image components of the CAPTCHA and submitting the manipulated image components to the system for entry/access to an online website or advertisement if the manipulation of one or more of the image components is correct;

To create and utilize a picture puzzle as a personal security key for access to a website, a user account, or a user device;

To create a security key from a captured image by generating a plurality of image components from the captured image, and altering at least one of the respective orientations, locations, or filter aspects of the plurality of image components;

To create a security key from a captured image by storing a particular sequence of modifying and/or reversing the modifications to a plurality of image components of the image; and

To equip a user with a personal security key which the user can solve faster than anyone else by providing the user with the sequence needed to solve the picture puzzle under timed conditions, and repeatedly testing the user.

In accordance with one embodiment of the invention, a system for playing a picture messaging game comprises a game server operatively coupled, via a network, to one or more computing devices. The game server includes a database for storing user data and game data, and at least one non-transitory computer-readable storage medium having computer-readable instructions stored therein to remotely perform the game, and at least one processor. The at least one processor is configured to execute the computer-readable instructions to receive an original image, generate a modified image based on the original image and one or more inputs to a first computing device associated with a first user, transmit a game request and the modified image to a second computing device associated with a second user, display the modified image on the second computing device, and prompt the second user, via the second computing device, to at least one of: (i) input a guess as to the original image; or (ii) transform the modified image into the original image.

In accordance with another embodiment of the invention, a computer-implemented system for establishing a security key comprises at least one processor configured to obtain an original image from a user, split the image into a plurality of original image components, display the plurality of original image components in a first electronic user interface on a first computing device associated with the user, receive, through the first electronic user interface, one or more inputs associated with one or more of the plurality of original image components, generate one or more modified image components from the plurality of original image components by altering one or more of the original image components based on the one or more inputs received through the first electronic user interface, and generate a security key for the user based on at least one of the modified image components or the one or more inputs.

Other objects, features, and characteristics of the inventive disclosure, as well as the methods of operation and functions of the related structural elements and the combination of parts and method steps, will become apparent upon consideration of the detailed description below with reference to the accompanying drawings, all of which form a part of this specification.

### BRIEF DESCRIPTION OF THE DRAWINGS

A further understanding of the inventive disclosure can be obtained by reference to preferred embodiments set forth in the illustrations of the accompanying drawings. The drawings are not intended to limit the scope of the inventive disclosure, which is set forth with particularity in the claims as appended or as subsequently amended, but merely to clarify and exemplify the inventive disclosure. Accordingly, a more complete appreciation of the inventive disclosure and many of the attendant aspects thereof may be readily obtained as the same becomes better understood by reference to the following detailed description when considered in conjunction with the accompanying drawings, where:

FIG. 1 is a schematic diagram illustrating exemplary system components and structure in accordance with the inventive disclosure;

FIGS. 2A and 2B are schematic diagrams illustrating exemplary components of, respectively, the game server and user devices of FIG. 1 in accordance with the inventive disclosure;

FIG. 3 is a schematic diagram illustrating exemplary system methodologies for playing a picture messaging game or generating and using a security key for game, computer, website, or account access in accordance with the inventive disclosure;

FIG. 4 is a schematic diagram illustrating a particular picture messaging game methodology of FIG. 3; and

FIGS. 5A-5X depict exemplary electronic user interfaces during performance of a picture messaging game in accordance with exemplary embodiments of the inventive disclosure.

### DETAILED DESCRIPTION

The present disclosure is not intended to be limited to the specific terminology selected, and it will be understood that each specific element includes all technical equivalents which operate in a similar manner. However, techniques, methods, systems, and operating structures in accordance with the invention may be embodied in a wide variety of forms and modes, some of which may be quite different from those in the disclosed embodiments. Consequently, the specific structural, functional and step-by-step details disclosed herein are merely representative. The embodiments herein are described in sufficient detail to enable those skilled in the art to practice the embodiments, and it is to be understood that logical, mechanical, and other changes may be made without departing from the scope of the embodiments. The following detailed description is therefore not to be taken in a limiting sense.

Each element in flowcharts depicted herein depict a step or a group of steps of a computer-implemented game, as well as game methodologies and various forms of security or encryption methodologies. Each step may contain one or more sub-steps. For purposes of illustration, these steps, as well as all other steps identified and described, are presented in a certain logical order. However, it will be appreciated that any exemplary embodiments described herein can contain an alternate order of the steps adapted to a particular application of a technique disclosed, and that any variations and/or modifications are intended to fall within the scope of the invention. The depiction and description of steps in any particular order is not intended to exclude embodiments having the steps in a different order, unless required by a particular application, explicitly stated, or otherwise clear from the context.

It will be appreciated that various modules of the systems, platforms, and methods described herein may be implemented by using an interfacing mobile app on an internet enabled mobile device's operating system, such as, for example, Android, iOS, or Windows Phone OS, and in part by using a web interface, and that different types of users may utilize different functionalities of the game system.

Systems described herein may include implementations through a combination of hardware and software that operate on a stationary or portable computing device, and may comprise various preprogrammed features combined and integrated with basic components, including but not limited to, one or more servers, databases, mobile end applications, web portals, network settings, etc. With the support of these components, the system provides the services and game or security functionalities through user interfaces such as a website or mobile applications. The system may have more than one server in a distributed structure with support from data centers located anywhere in the world. Implementations may be communicatively linked and cross-platformed so that a user may be provided with information relevant to their game(s) and/or other game participants. The system may function on more than one computer architecture, operating system, application software, application programming interface (API), web application, etc. It will be appreciated that computer program instructions used by systems described herein and/or the apps for use with the system may include computer executable code in one of a variety of languages, including C, C++, Java, JavaScript, etc.

Various embodiments of the systems and methodologies described herein allow a user to create a personalized picture messaging game, challenge, or puzzle on his or her mobile device using one or more user interfaces. The user can capture and modify an original image, and forward the modified image as part of a game, challenge, or puzzle to a participant (e.g., a friend, relative, or any other user of the system) under timed conditions or other constraints. The recipient of the game challenge, upon acceptance, attempts to manipulate the modified image back to what he or she believes is the original image, and is allowed one or more guesses as to the name or other label of the image. Simultaneous picture messaging games can be conducted between remote game participants, during which the game participants attempt to solve a particular picture messaging game created by the user under timed conditions or other constraints.

Various other embodiments of the systems and methodologies described herein make use of picture capture and picture manipulation for security purposes. For example, a web designer or owner may make use of a picture puzzle as a form of CAPTCHA (Completely Automated Public Turing test to tell Computers and Humans Apart) for differentiating computers from human users attempting to access the owner's website or website content. A mobile device user may instantly create and make use of a personalized picture puzzle (and/or method or particular sequence for solving the picture puzzle) as a personal security key required to access his or her mobile device(s), website(s), user account(s), and the like.

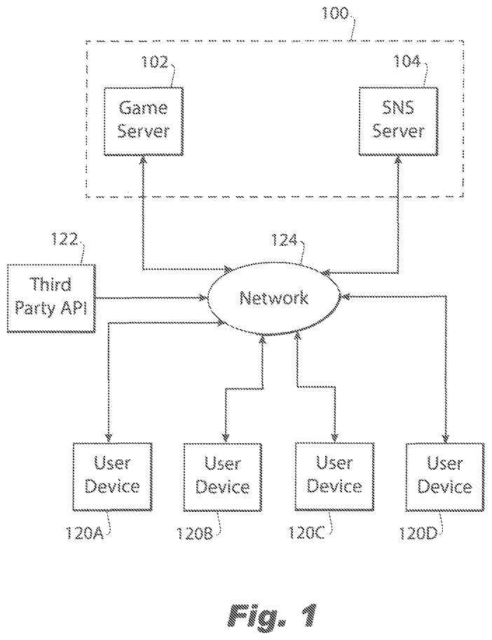

The systems and associated methodologies described herein are best understood with reference to the drawings, which are described in detail below. Referring first to FIG. 1, illustrated is a diagram of an exemplary computing system 100, a plurality of peripheral remote user computing devices 120A, 120B, 120C, 120D, and at least one third party API 122 for use with various exemplary embodiments of the inventive disclosure. A combination of hardware and software operates on computing devices 120A-120D and computing system 100, generally with one or more connections to wired or wireless network 124 (e.g., a wide area network (WAN) such as the Internet), incorporated with local devices through a local area network (LAN) interface (not shown). Computing system 100 can include, for example, game server 102 and Social Networking Service (SNS) server 104. It will be appreciated that the game system and methodologies described herein can be used in conjunction with, as part of, or remote but operatively coupled to social network server 104. Game server 102 is operatively coupled to user devices 120A-D via network 124.

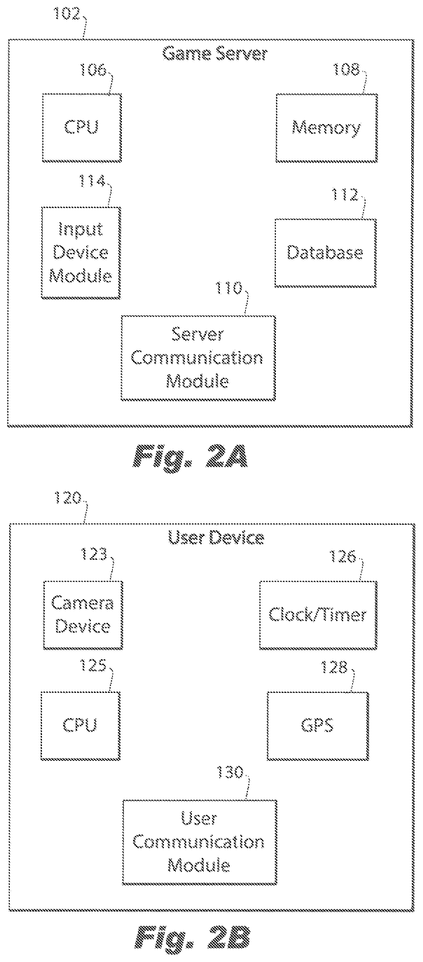

Referring to FIGS. 2A and 2B, game server 102 may include central processing unit or control unit (CPU) 106, which executes programs stored in memory 108 to perform various types of processing, and transmits and receives data to/from user computing devices 120A-120D through network 124 via server communication module 110. Memory 108 may include, for example, a hard disk drive or a memory such as R.A.M., and may store various programs such as a game program, game data, etc. Game server 102 may also be configured to function as a general server for purposes other than performance of picture messaging games described herein. For example, game server 102 may be configured to provide a security key, via CPU 106, for security purposes (further discussed below), and may work in conjunction with third party API 122 to provide such functionality. Game server 102 may also be configured in communication with Social Networking Service 104 for communicating and receiving user profile data and user network data associated with other of a user's online activities for advertisement and analytics purposes.

Game server 102 may also include database 112 for storing data received during user registration and each game, connections made with other users, results of games sent or received, inputs from users during games, etc. For example, such stored information may include user profile data, names, addresses, phone numbers, associated devices, IP addresses, associated pictures, prior game data, user connections and networks, social media connections, uploaded content, text messages, communications, captured images, prior games, one or more sequences relating to solving a picture puzzle, current and past security keys, information concerning the users' devices, privacy settings, preferences, interests, occupations, relatives, etc.

In certain embodiments, database 112 may also categorize such stored information based on pictures or other content uploaded by users, or by user choice. Input device modules 114 may also be provided in conjunction with server communication module 110, and operatively coupled to external PCs or mobile devices to input commands from administrators of system 100.

As discussed above, each user device 120 (120A-120D) may be any user computing device such as a mobile phone, a smartphone, a laptop computer, a desktop computer, a tablet, and the like. User device 120 may include a camera device 123, a central processing unit 125, a clock or time device 126, a GPS location identifier 128 configured to identify a location or geolocation of a user via communication with global positioning system (GPS) or similar technology, and a user communication module 130 for communicating with game server 102 via network 124. It will be appreciated that in certain embodiments, user device 120 may simply be a terminal, and that some or all of the functionalities of these components may be provided by a remote computing device such as CPU 106 of game server 102. In certain embodiments, camera device 123 may be remote from user device 120 and configured to capture a digital image which can be later transferred to user device 120 and/or game server 102 by email, text, MMS, or any other suitable means through network 124.

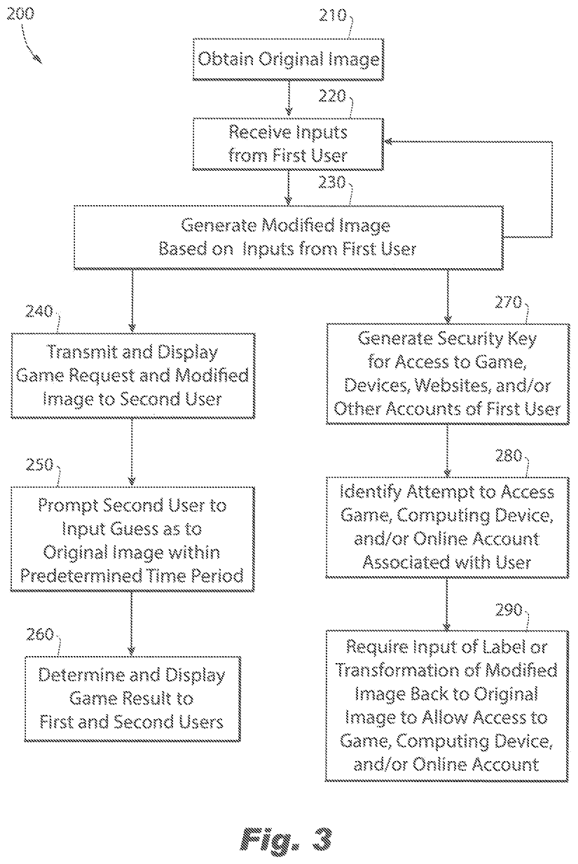

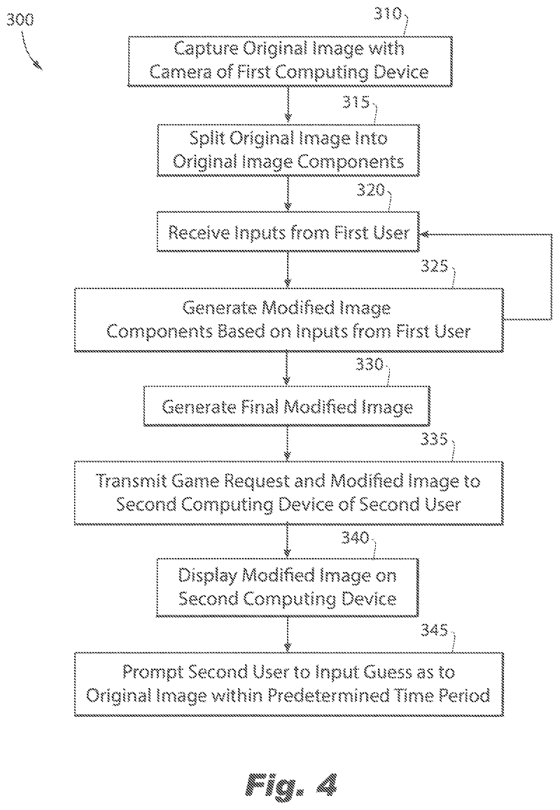

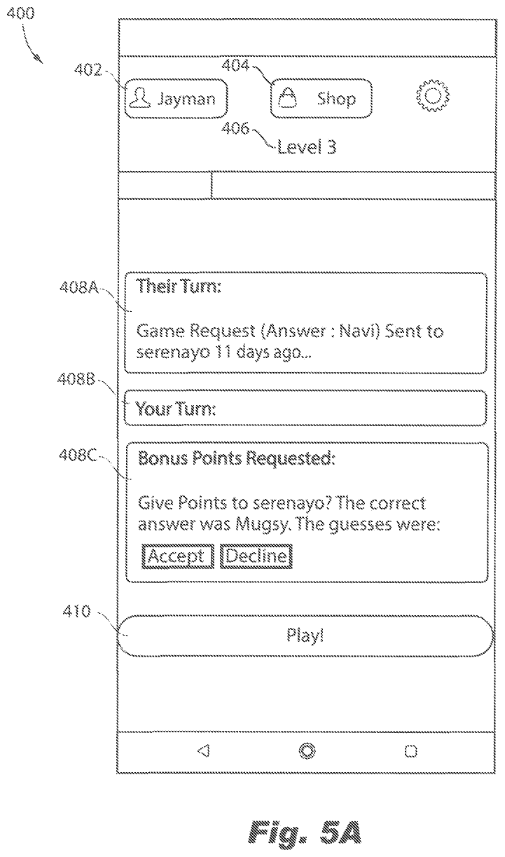

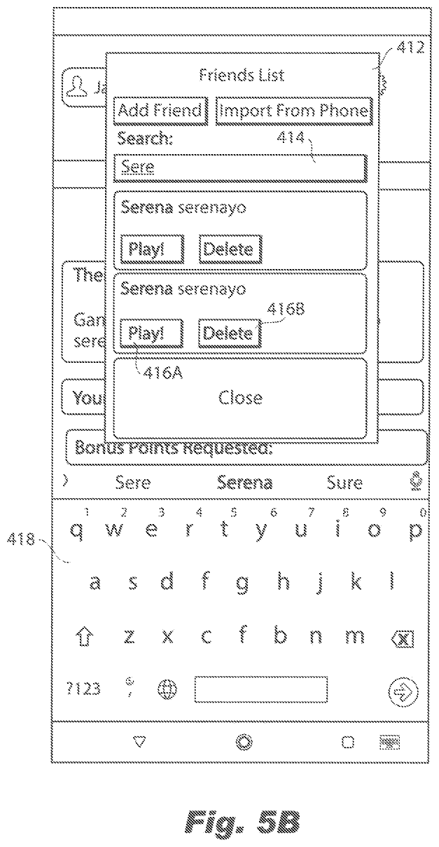

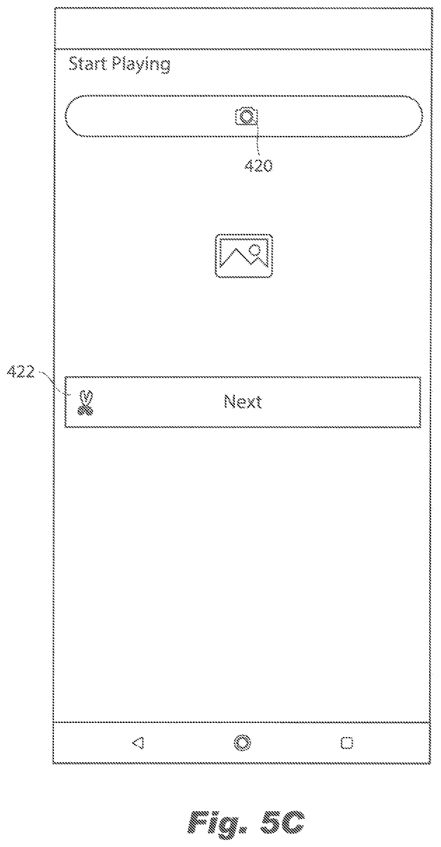

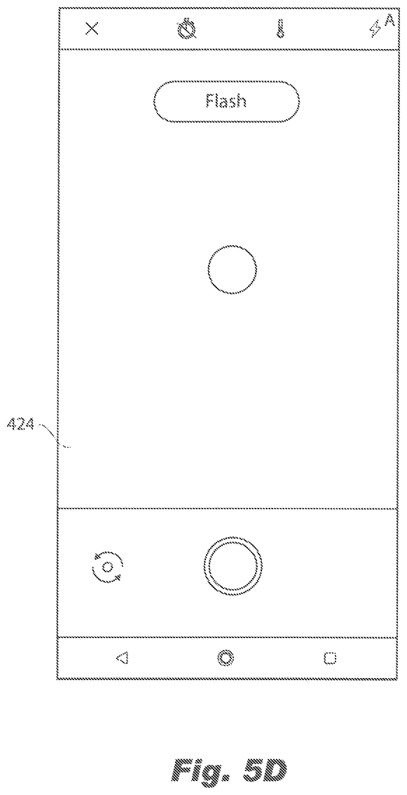

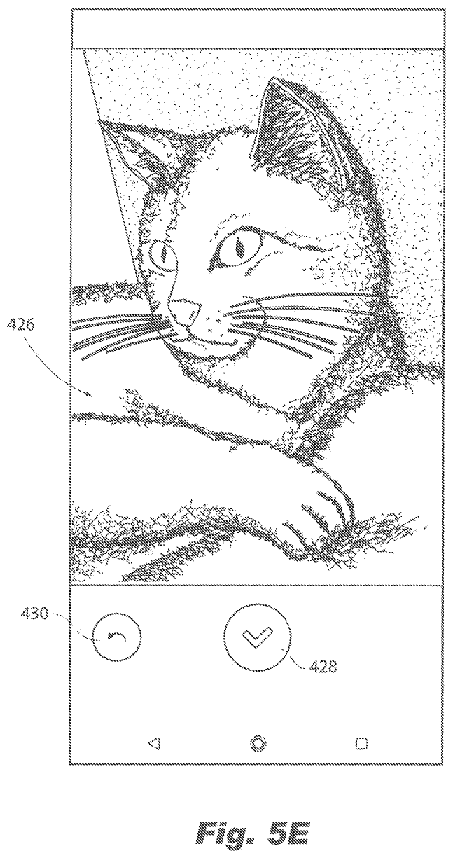

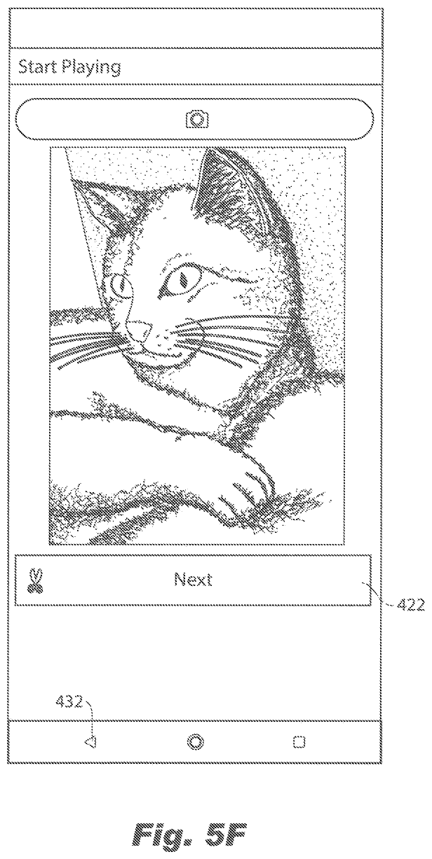

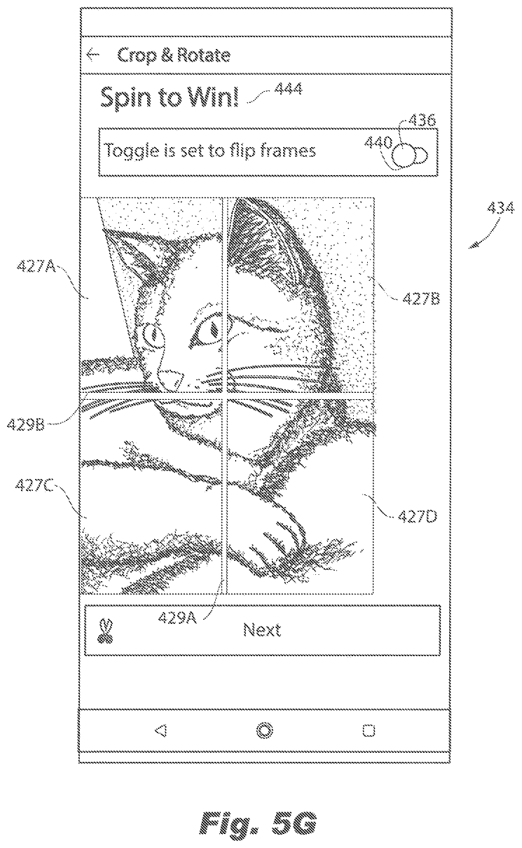

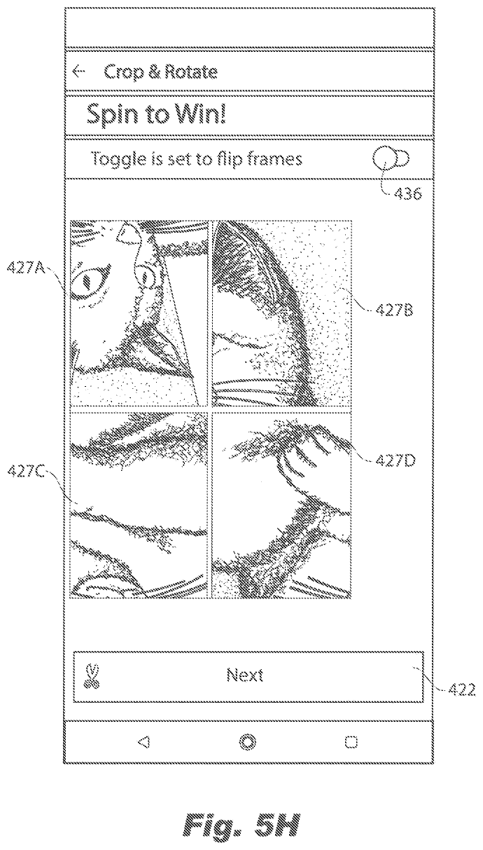

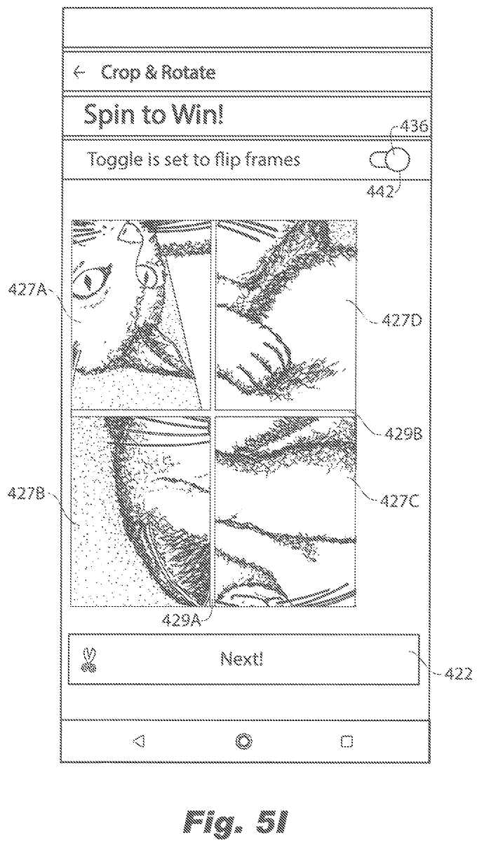

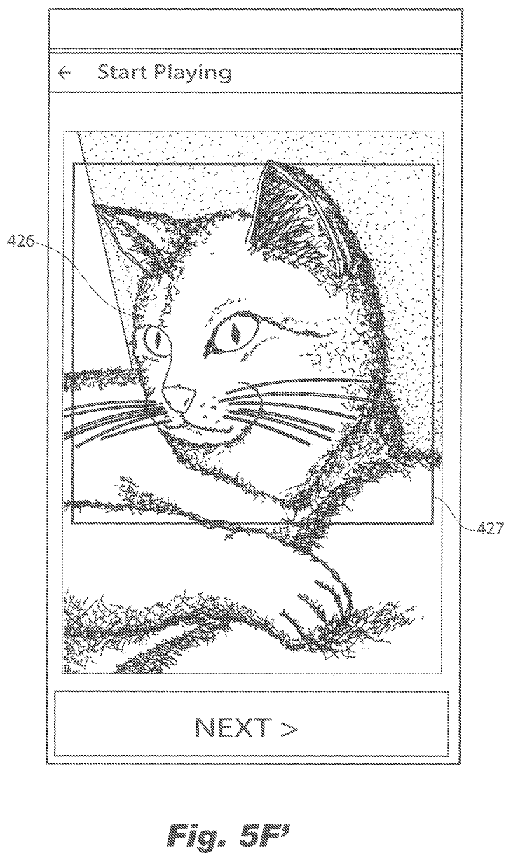

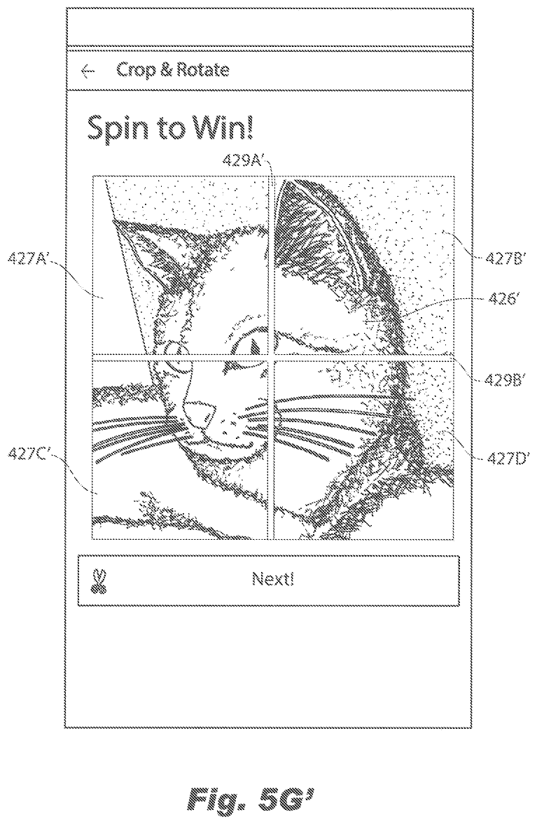

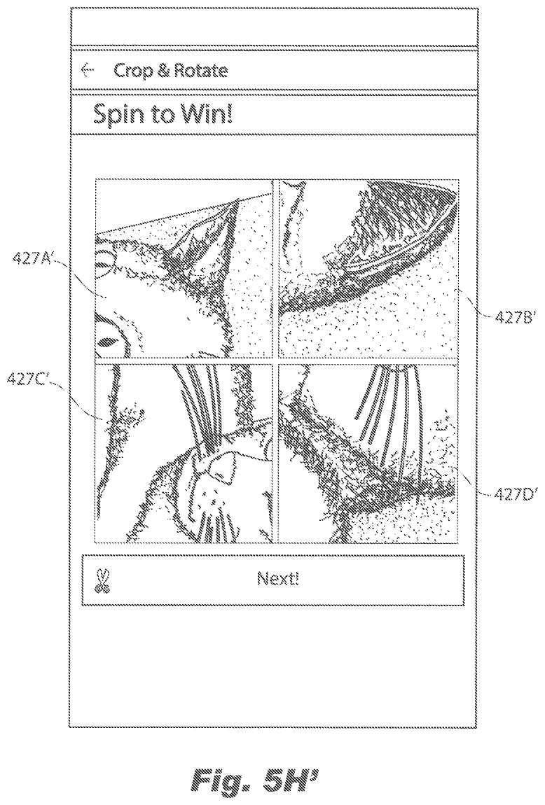

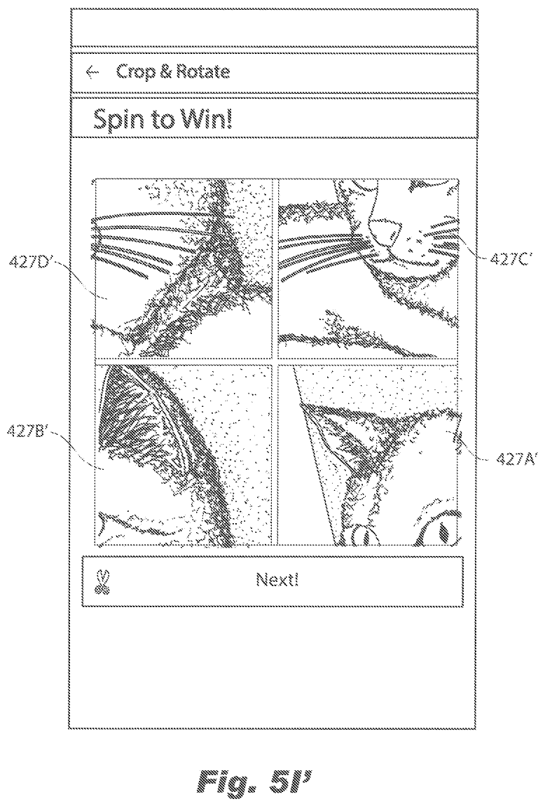

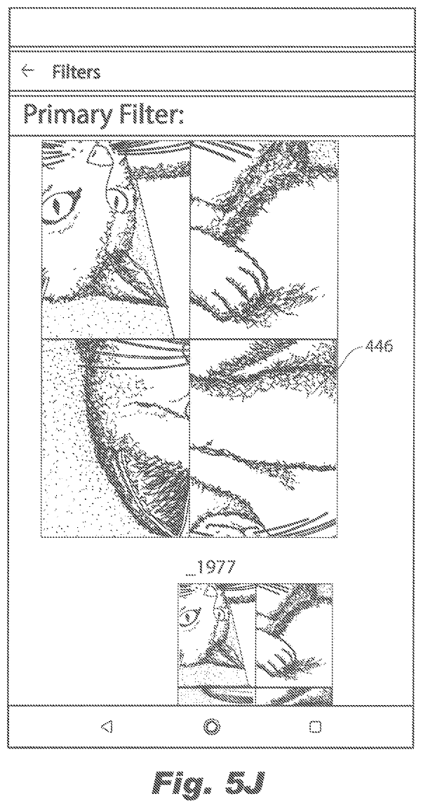

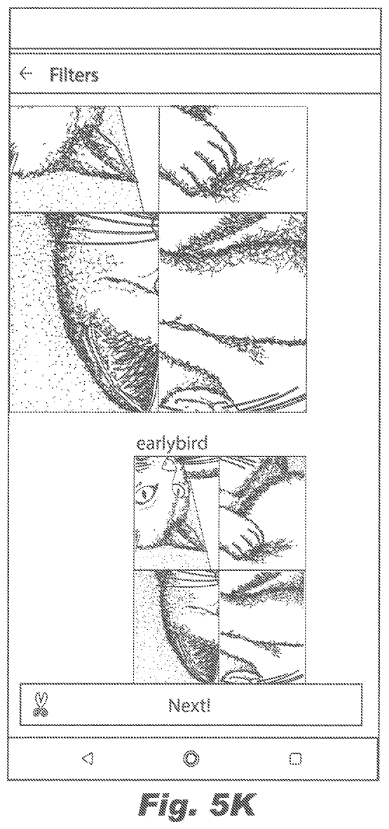

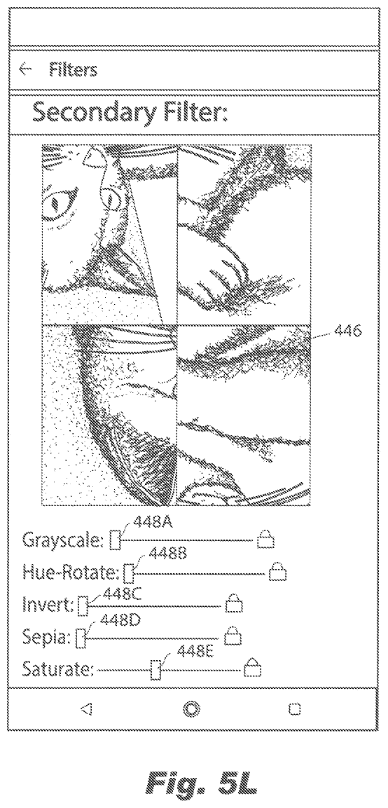

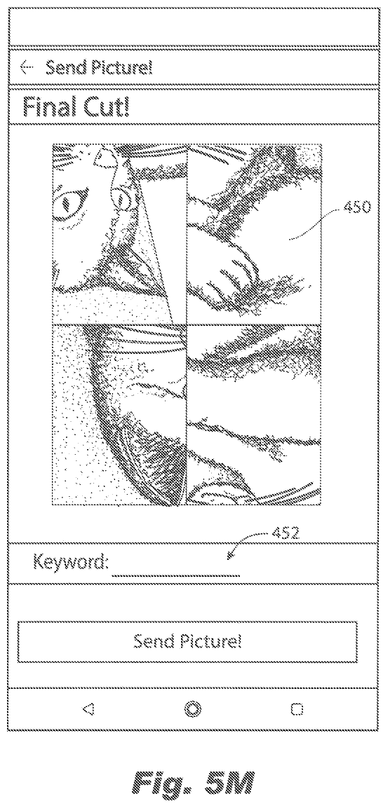

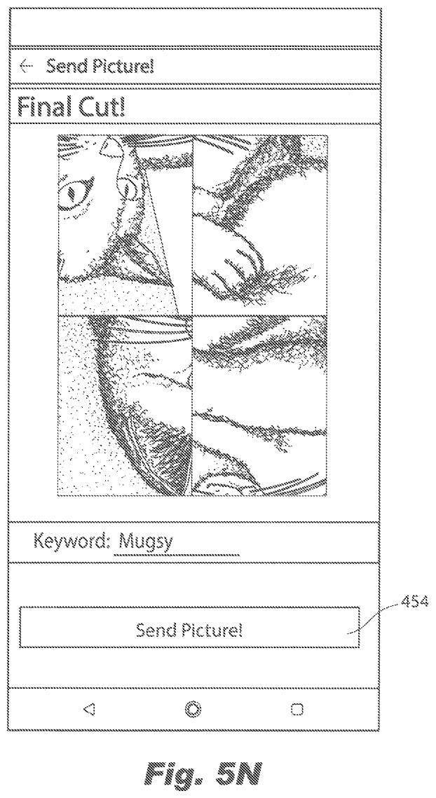

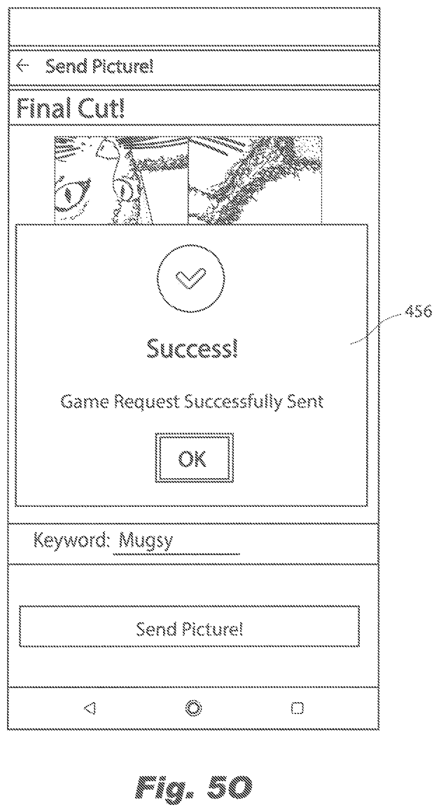

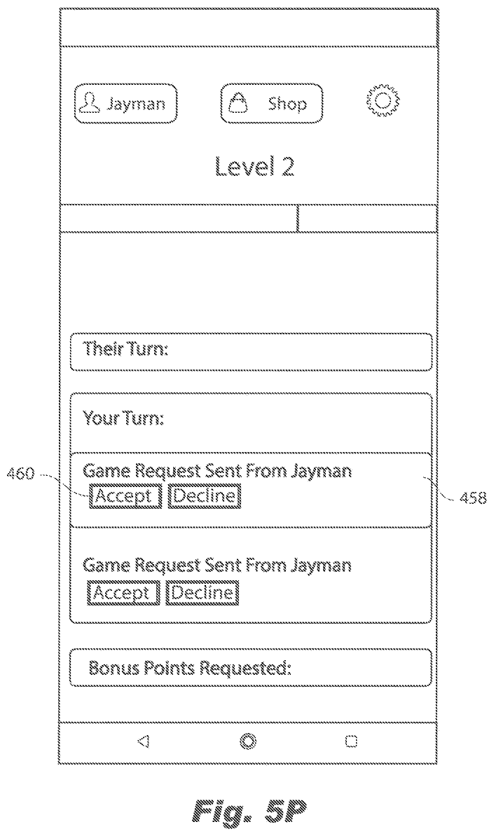

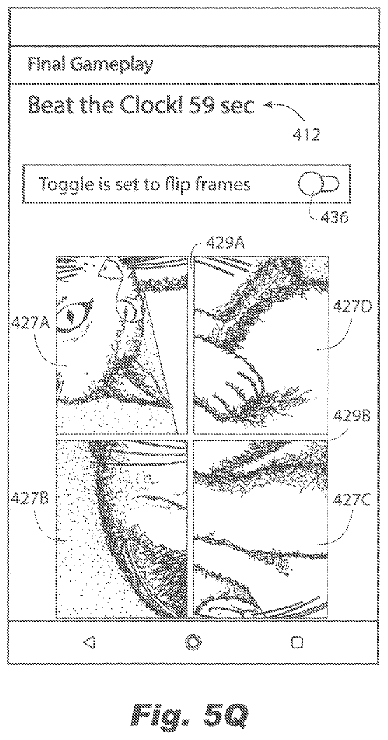

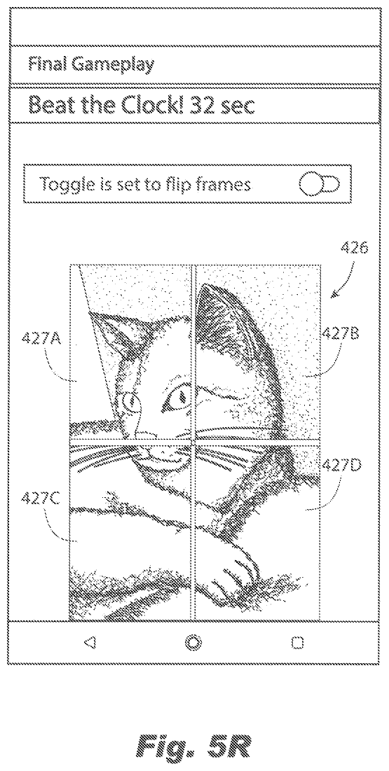

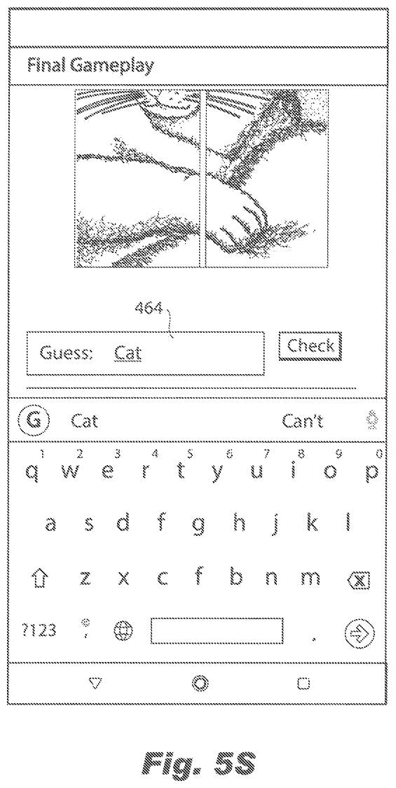

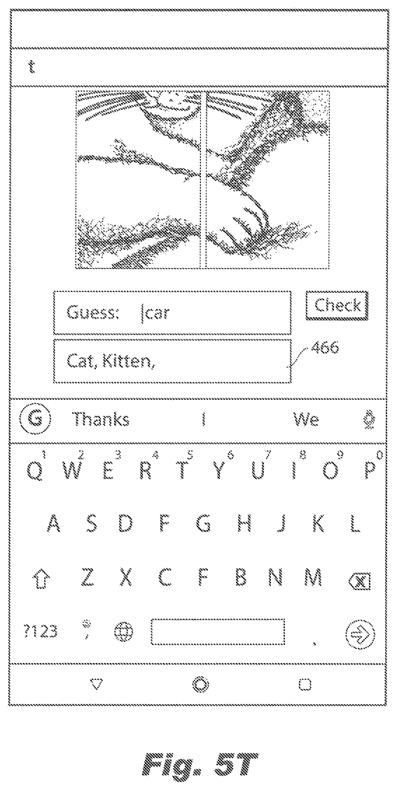

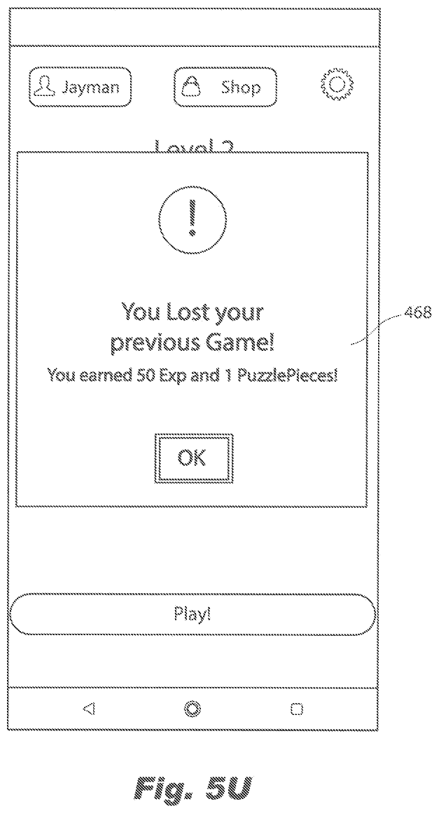

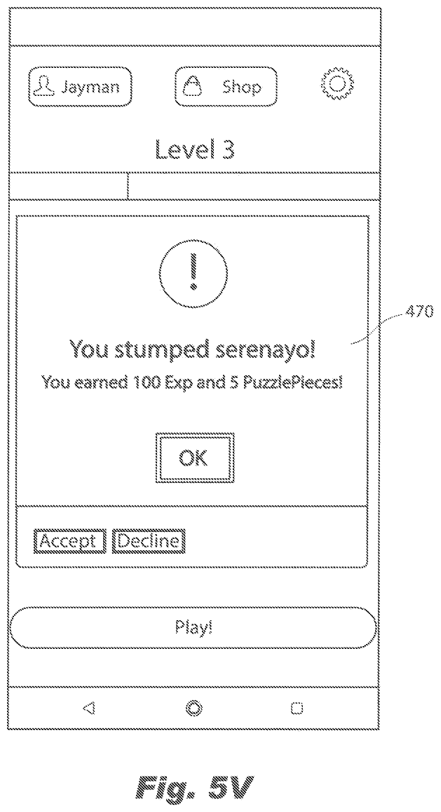

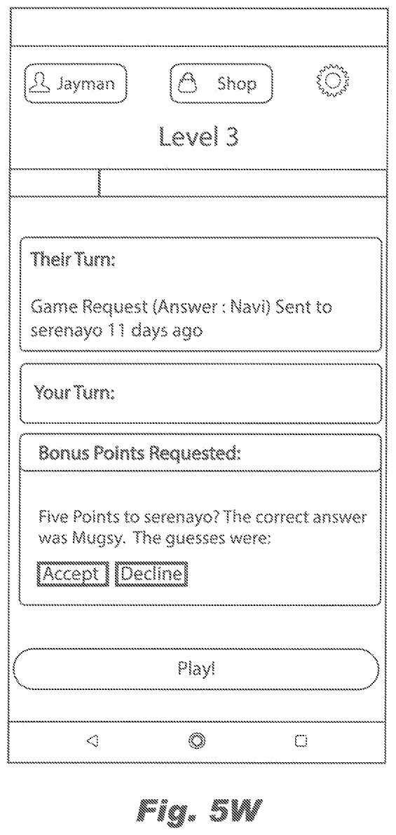

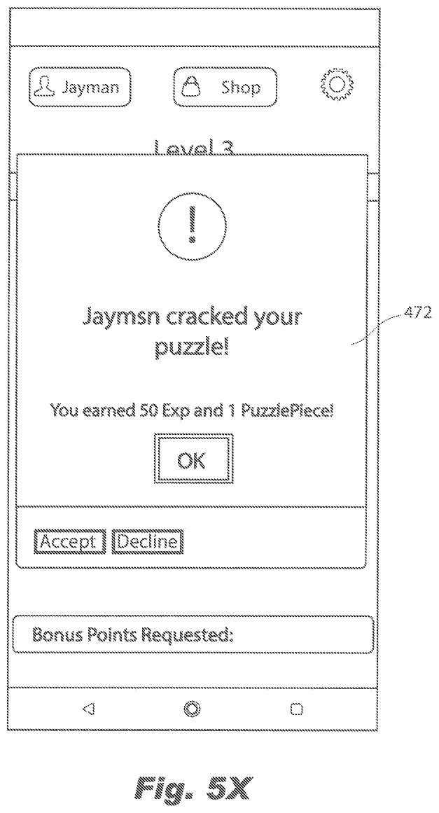

Referring to FIG. 3, a schematic diagram illustrates an exemplary overall methodology 200 for playing a picture messaging game and/or generating and using a security key for a game, a computer, a website, or access to an account in accordance with exemplary embodiments of the inventive disclosure. A more detailed description of exemplary embodiments of a picture messaging game in accordance with overall methodology 200 is further described below with respect to FIGS. 5A-5X.

As shown in FIG. 3, at Step 210, system 100 obtains an original image, preferably from camera device 123 of user device 120A, and stores the original image in database 112. The image may be a current picture taken by camera device 123, an old image on camera device 123, or an image forwarded from another device. A user (e.g., a first user of user device 120A) may optionally input a label (e.g., a name) for the original captured image. System 100 also stores the label for the original image in database 112.

At Step 220, the first user enters one or more inputs into user device 120A via an electronic user interface (further discussed below with respect to FIGS. 5A-5X) to alter the original image.

At Step 230, system 100 generates a modified image based on the original image and the inputs received from the first user, and may store the modifications (as well as the sequence thereof) made to the original image in database 112. For example, system 100 may store each change the user makes relative to the original uploaded image. System 100 may also display the modified image on user device 120A after each change thereto (e.g., through communication with an app running on the first user's user device 120A, through a website, a personal desktop PC, or through any other suitable means). As shown, Steps 220 and 230 may be repeated until the first user is satisfied with the modified image, in which case the first user may notify system 100 that he/she is finished with modifications. System 100 may then store the final modified image in database 112.

At Step 240, upon further input from the first user, the final modified image and a game request are transmitted to a second user device (e.g., 120B) of a second user of system 100. If the second user (e.g., a participant user) accepts the game request, then the modified image is displayed by second user device 120B in an electronic user interface (further discussed below with respect to FIGS. 5A-5X).

At Step 250, the second user is prompted, via the electronic user interface of second user device 120B, to input one or more guesses as to the original image within a predetermined time period. The predetermined time period can be any time period, may be set in advance, or may be set in real time by the first user. In certain embodiments, sixty seconds is the amount of time a user has to input a guess. In other embodiments, no timer is used and other constraints such as a predetermined number of guesses as to letters and/or words are utilized. In yet other embodiments, a hangman style game may be utilized and displayed as the second user attempts to guess the original image (further discussed below with respect to FIGS. 5A-5X).

At Step 260, system 100 determines a game result based on whether the predetermined time period has elapsed and/or whether the second user has inputted one or more guesses which include a correct guess (e.g., a guess which matches the first user's label for the original image, or at least one guess which the first user will consider an acceptable guess).

In certain embodiments, such as during an initial setup, user registration, or simply during a given game, instead of using the final modified image for a game request, the first user may instead be given the option to generate a security key based on the final modified image (Step 270). By way of example, as a user will be familiar with the image he/she has modified, the original image with which he/she started, and the general sequence of inputs required to convert the modified image back to the original image (and vice versa), the user can use the final modified image as an “authentication key” to enter various of the first user's devices or accounts, or to enter various websites and/or accounts or software provided at particular websites.

By way of example, after repeated changing back and forth between the original image and the final modified image under timed conditions (e.g., during a solitary game in which the first user repeats Steps 220 and 230). Instead of continuing to modify an original image, the first user may practice repeatedly modifying the original image to the final modified image, and/or modifying the final modified image back to the original image. In this manner, the first user may become highly conversant with his/her original and modified images and be able to convert one to the other faster than anyone else could under timed conditions. Thus, the first user can set the final modified image as a security key with a time period of five seconds, ten seconds, twenty seconds, etc., or any other time period the first user desires, to convert the modified image into the original image in order to be allowed access to the user's device, account, online website, or server. In this manner, the first user may safeguard his or her devices and/or accounts online. It will be appreciated that such a security key will be easier for the first user to remember, and could be be used on multiple of the first user's devices or accounts.

The first user may supplement this security feature by inputting a label to describe the original image and additionally require input of the label (or an input very close thereto) to be allowed access. In this manner, the first user can create his/her own personal “lock” based on a familiar image which may have sentimental value to the first user. If, for example, the first user uses an image of his/her backyard, he might enter the label ‘home’, generate a modified image, and allow twenty seconds to unlock his home. Such functionality could be used as a screensaver, on a cell phone, an online account, entry into a website, etc.

In certain embodiments, other aspects of the security key functionality may be provided by third party API 122 hosted on a cloud application platform as a service (PaaS) such as, for example, Heroku, in operative communication with user device 120 and database 112. In such embodiments, changes to database 112 relating to the security key functionality may be first processed via API 122. Aside from the API's innate security protocols, it will be appreciated that different security measures can and may be implemented to protect communication between system 100 and API 122. By way of example, system 100 may generate a random security key that may be validated and encrypted with a salt and cryptographic hash function. The security key may be encrypted via the Data Encryption Standard (DES) or any other encryption standard. Any image transfers to third party API 122 may be done, for example, via two methods, “btoa” and “atob,” which respectively encrypt and decrypt base64 data. The base64 string image data may be encrypted client side via the btoa method. Once received by API 122, API 122 may decrypt the data via the atob method and use the data to upload the original and/or modified images to a separate database (e.g., in addition to database 112).

In certain embodiments, once the first user is satisfied with the modified image, system 100 can save the final modified image (as well as all modifications made to the original image and the order thereof) in database 112. In this manner, system 100 can be configured to show the first user (e.g., by display) the opposite sequential steps needed to convert the modified image back to the original image so the first user can practice “unlocking” the modified image to reveal the “key” (e.g., the original image) as described above.

At Step 280, when someone attempts to access the first user's online account or device, the modified image may be displayed with a prompt to unlock the key with a timer that counts down, whereby the person would need to “unlock” the key within a predetermined time period set by the first user.

At Step 290, once the modified image is displayed, the user may also be required to input the label corresponding to the original image (e.g., in addition to transforming the modified image back to the original image). The time period set for the security key is preferably very short (e.g., ten to twenty seconds) so that a fraudulent user could never perform the transformation in the time allotted, at least not in the first few tries. If there is an unauthorized access attempt (e.g., an attempt which fails due to expiration of the predetermined time period and/or input of an incorrect label), then the first user may be notified via email, text, or other means, and asked to confirm whether he/she is the one attempting to access the first user's device or account (assuming of course that the first user can confirm or deny such attempt from a different device or account than the one for which access is being attempted). The first user may also be given the option to change the security key with a new image, a new modification sequence, and/or a new label.

In other embodiments, system 100 may be utilized to present various forms of CAPTCHA as an original image. For example, system 100 may present a modified for “unlocking” by a user in the manner described herein (examples of modifications are described below with respect to FIGS. 5A-5X). In yet other embodiments, upon transforming the modified image into the original image within a predetermined time-frame, a user may be able to then decipher text and/or other CAPTCHA in the image, whereby a program or bot could not simulate the user and gain access. In other embodiments, a grid of images may be presented to the user with each image oriented differently. A first authentication may require the user to orient and/or rearrange all images correctly in order to be presented with a secondary task, which may then be displayed to the user (e.g., ‘select all images that have trees in them’ or ‘enter the captcha shown in the image’). The secondary task may also have a predetermined time-frame in which to be completed so that a program or bot could not simulate the user to gain access. In yet other embodiments, the original image may be the text CAPTCHA itself. The user would be required to transform the modified image back into the original image within a predetermined time-frame, whereby a program or bot could not simulate the user to gain access. By recreating the text CAPTCHA in its entirety, the user would then have to input the text (now decipherable) into a field and have it accepted as matching the original CAPTCHA.

In certain embodiment, similar to current image CAPTCHA, interactive CAPTCHA may be provided by system 100 which use a preapproved set of permutations to complete a puzzle, which will test whether a user is actually human. It will be appreciated that such functionality may be accomplished via several different means. By way of example, system 100 may execute a function or algorithm which divides an image into a random number of square or other shaped pieces and performs a random number of rotations and placement or location changes of the pieces. System may save such permutations and expect the user to place the modified and/or displaced pieces back into the original order, orientation, and/or spacing. In such embodiments, once the image is divided into a grid of (e.g., square pieces), system 100 may attach unique values to each piece.

For example, each piece of a CAPTCHA image may be assigned a current position ID and a correct position ID respectively corresponding to the current position of the piece in the grid and the position (e.g., the relative position) it should be in for the solved CAPTCHA. Similarly, system 100 may assign each piece a current rotation ID and a correct rotation ID respectively corresponding to the piece's current rotational orientation and the correct rotative orientation in the solved CAPTCHA. Thus, once each piece (or once a predetermined number or percentage of the pieces) of the CAPTCHA image is/are manipulated by the user into the correct position/location and/or rotational orientation, the software deems the CAPTCHA successfully solved.

This mode of determining success in solving puzzles (e.g., assigning point values for location(s) and/or rotational orientation of pieces) may also be utilized in the embodiments of the picture messaging games described herein, the details of which are further described below with respect to FIG. 4 and FIGS. 5A-5X.

Referring to FIG. 4, an example picture messaging game methodology 300 is shown in accordance with various embodiments of the inventive disclosure. At Step 310, system 100 obtains the original image with camera device 123 of user device 120A. At Step 315, system 100 splits the original image into original image components, and displays the split image to the first user, preferably with the original image components offset from one another and visually delineated.

System 100 then receives one or more inputs from the first user with regard to one or more of the original image components (Step 320) via user device 120A, and generates one or more modified image components (Step 325) from the original image components based on the inputs received from the first user. As shown, Steps 320 and 325 may be repeated until the first user is satisfied with the modified image.

Upon generation of the final modified image (which may be indicated by the first user's approval input) from the one or more modified image components (Step 330), system 100 may transmit the final modified image with a game request to a second computing device 120B of a second (participant) user (Step 335), and display the game request and/or final modified image on second computing device 120B (Step 340) if the second user accepts the game request. The second user may then be prompted to input a guess as to the original image within a predetermined time period (Step 345), or within a predetermined number of guesses.

Referring now to FIGS. 5A-5X, shown are electronic user interfaces displayed by user device 120 during performance of a picture messaging game in accordance with exemplary embodiments of the inventive disclosure. As shown in FIG. 5A, user device 120A may have a display screen which displays various icon or application images of an application program in a first electronic user interface 400. User interface 400 may include a username icon 402, a store button 404 for purchase of one or more items from an online store (e.g., such as filters which are otherwise locked, a free guess, points toward future purchases, etc.), a level indicator 406 (e.g., difficulty level), status windows 408A, 408B, 408C, and a play button 410.

As shown, status window 408A shows the last game request which was sent by the first user. Status window 408B shows whether any game requests have been sent to user device 120A from other users of system 100 which have not yet been attempted. In this situation, no game requests are pending. Status window 408C inquires whether any bonus points should be awarded to Serenayo, a user to whom a game request was sent eleven days ago as shown in status window 408A. The label of the original image sent to Serenayo in the game eleven days ago was “Mugsy” as shown in status window 408C, which lists the guesses attempted by Serenayo (in this situation, no guesses were attempted).

In certain embodiments, the picture messaging game can be set up such that an exact match of the label of the original image is required for the participant user to win a game. In other embodiments, a predetermined number of correct characters of the label in the correct relative location may be needed to win the game. In yet other embodiments, full discretion may be given to the sender of the game request (e.g., the first user) as to whether any of the guesses inputted by a second participant user suffices to win the picture messaging game.

As shown in FIG. 5B, depression of play button 410 prompts friend search window 412, where the first user can do a search of users in system 100 or among his/her friends. Here, typing text string ‘sere’ into search box 414 brings up two user names containing the text string. Push buttons 416A, 416B allow the first user to either initiate a new game with a particular user or to delete the particular user from the first user's friends. Keyboard 418 allows for input of text.

As shown in FIG. 5C, once a game is initiated, the first user is shown camera icon 420 and is instructed to start playing by depressing push-button 420, which brings the first user to picture screen 424 (FIG. 5D). The system may configure push-button 422 to be engageable once an image is taken with camera device 123. Camera device 123 is initiated on user device 120A with whatever settings the user presets. The user can then use the camera to take a picture, preferably vertically.

In FIG. 5E, the first user has captured an original image/picture of his cat 426. Checkmark push-button 428 may be depressed to select this picture. Arrow push-button 430 may be depressed to retake the picture. The user is then brought back to the main screen (e.g., the electronic user interface of FIG. 5C) with the original image 426 of FIG. 5E inserted into the user interface of FIG. 5C (FIG. 5F). Push-button 422 may then be depressed again. At any time, the first user may index back using back arrow 432.

s shown in FIG. 5G, original image 426 is split into four original image components 427A, 427B, 427C, and 427D with vertical and horizontal borders 429A, 429B. As shown in this electronic user interface 434, a toggle 436 is provided which is horizontally translatable along a slot 438 to a first position 440 which corresponds to a flip-frames (e.g., rotate frames) mode (FIG. 5G), and second position 442 (FIG. 5I) which corresponds to a switch frames (e.g., swap frames) mode. Continuing with reference to FIG. 5G, when the toggle is at first position 440, the first user can rotate one or more of original image components 427A, 227B, 427C, and 427D by touching them. In certain embodiments, each original image component is rotatable by 180 degrees at a time by clicking or touching it on-screen. In other embodiments, each image may be rotated 90 degrees at a time by clicking or touching it on-screen. One or two touches may be required to rotate an image component. In yet other embodiments, a spin-to-win message 444 may be depressed to rotate all original image components at once, or to rotate selected images. In such embodiments, system 100 may automatically spin each image component a random or a predetermined number of times (unknown to the first user). In yet additional embodiments, such an automatic spin feature may randomly select one or more of original image components 427A, 227B, 427C, and/or 427D for spinning.

In embodiments where original image 426 is captured vertically by camera 123 or another device, it will be appreciated that original image components 427A, 427B, 427C, and 427D will have longer vertical axes than horizontal axes. Thus, in such embodiments, such image components are preferably rotatable by 180 degrees at a time (e.g., “flipped”). In other embodiments, where the original image components form a perfect square, system 100 may be configured to create 90 or 180 degree rotations of each image component as determined by user input (e.g., one or two taps). In certain embodiments, system 100 may be configured to allow a user to rotate one or more of image components 427A, 427B, 427C, and 427D by touching the screen of mobile device 120A at, for example, a corner of one of the image components, making an arcuate clockwise or counter-clockwise motion on-screen, and releasing the image component.

Referring to FIG. 5H, original image components 427A, 427C, and 427D have all been rotated 180 degrees, whereas original image component 427B has not been rotated. Toggle 436 is still set to flip frames mode. When the user is done rotating the image components, he/she may depress the next push-button 422.

As shown in FIG. 5I, toggle 436 has been translated to second position 442, which corresponds to a switch frames mode. In this mode, the relative position of the original and modified image components may be changed. As shown, image components 427A is in the same location as it was in FIG. 5H, but component 427B is now in the location where component 427C was, component 427C is in the location where component 427D was, and component 427D is in the location where 427B was located. Additionally, while components 427A and 427C have maintained the same rotational orientation as they had in FIG. 5H, components 427B and 427D were rotated again 180 degrees before they were moved. It will be appreciated that a user can continually rotate and switch frames by moving toggle 436 back and forth between the first and second positions 440, 442, as long as the user wants to scramble/modify the original image or continue modifying the modified image. System 100 may be configured with or without toggle 436. Frames may be swapped by, for example, selecting, dragging, and dropping them, and rotated by tapping them.

For example, the first user may either drag and drop an image component to a new location (in which case the image component already in that location is automatically moved to the location currently occupied by the image the user is trying to move), or the user can simply click on two image components back-to-back to switch them. In other embodiments, system 100 may be configured to automatically move the image component locations in a clockwise or counterclockwise direction based on user input (e.g., two clicks to automatically rotate). In yet other embodiments, a single click on a picture may rotate it and a drag and drop may move it.

It will be appreciated that in embodiments where each component is rotatable by 180 degrees and movable to any location of the four by four matrix of locations, there are three hundred and eighty four (384) possible combinations using these rotation and relocation functionalities. By way of example, there are twenty four (24) possible arrangements based purely on location as shown in Table 1 below.

TABLE 1

| | | | |
|---|---|---|---|
| AB | BA | CA | DA |
| CD | CD | BD | BC |
| AB | BA | CA | DA |
| DC | DC | DB | CB |
| AC | BC | CB | DB |
| BD | AD | AD | AC |
| AC | BC | CB | DB |
| DB | DA | DA | CA |
| AD | BD | CD | DC |
| BC | AC | AB | AB |
| AD | BD | CD | DC |
| CB | CA | BA | BA |

Just taking one of these (e.g. the ABCD example in the first row, first column of Table-1 above), since each image component has two rotative positions (rotatable by 180 degrees), there are 16 possible rotative orientation combinations as shown in Table-2 below.

TABLE 2

| | | | |
|---|---|---|---|
| AB | A′B | AB′ | A′B′ |
| CD | CD | CD | CD |
| AB | A′B | AB | A′B |
| C′D | C′D | CD′ | CD′ |
| AB′ | A′B′ | AB | A′B |
| C′D | C′D | C′D′ | C′D′ |
| AB′ | A′B′ | AB′ | A′B′ |
| CD′ | CD′ | C′D′ | C′D′ |

In Table-2, A′ refers to the 180 degree rotation of component A, etc. Thus, there are 16×24=384 possible combinations of image components 427A, 227B, 427C, and 427D in terms of their location and rotational orientation. Given enough time, with only these constraints, if a user methodically tries each combination, he/she can eventually create the original image from any modified image. Thus, at least one of a timer and various filtering means may be used in conjunction with the game as further discussed below.

Referring to FIGS. 5F′ to 5I′, in certain embodiments, original image 426 may be cropped by the user using a cropping tool 427 to create a square image from the original elongated image (FIG. 5F′). The resulting cropped square image 426′ may similarly be split into four cropped original image components 427A′, 427B′, 427C′, and 427D′ with vertical and horizontal borders 429A′, 429B′ (FIG. 5G′) which may then be rotated (FIG. 5H′) and/or rearranged (FIG. 5I′). It will be appreciated that in such embodiments, original image components 427A′, 427B′, 427C′, and 427D′ will have equally sized vertical and horizontal axes (e.g., will be square-shaped), and rotatable by ninety (90) degree increments. There will still be 24 possible arrangements as per Table-1 above (e.g., still a 2×2 matrix), but now four rotative positions for each image component instead of two. Thus, there are 256 rotative orientation combinations (44), and 256×24=6,144 possible combinations of image components 427A′, 227B′, 427C′, and 427D′ in terms of their location and rotational orientation, rendering the puzzle much harder to solve by process of elimination.

Referring to FIG. 5J, once the user has selected/clicked/touched the ‘next’ push-button in the electronic user interface of FIG. 5I, a modified image 446 is generated and displayed for the user from modified image components 427A′, 427B′, 427C′, and 427D′ as they appear in FIG. 5I, without vertical and horizontal borders 429A, 429B.

As shown in FIGS. 5K and 5L, various primary and secondary filters may be applied to modified image 446, including adjustable grayscale, hue-rotate, invert, sepia, and saturate. As shown, these filters are locked, but can be unlocked by a user via a small purchase from shop 404 (FIG. 5A). Various levels of these filters may be applied to the modified image of FIGS. 5K and 5L in order to further complicate the puzzle for a participant user. For example, in image components 427A and 427D, certain features of the cat (e.g., a portion of the head and a paw) can be more clearly seen than other features of the cat in image components 427B and 427C. Image components 427A and 427D may thus be significantly darkened or blurred to make the puzzle a bit more complicated or confusing for a participant user. In certain embodiments, these filters may all be unlocked and free for the user to apply to make the image components even more difficult to ascertain. The filters may be applied using slidable pegs 448A-E, and may be applied to individual image components or to all image components at once.

In yet other embodiments, the filters may be divided into two categories, primary and secondary. The user may be enabled to use one primary filter at a time, and to mix and match secondary filters in order to make the modified picture puzzle more difficult to solve. The secondary filters may be subcategorized into “pro” filters and “prime” filters. Variance of the prime filters may cause a more significant visual change to an image, and may be more costly to purchase. In certain embodiments, a user may be able to purchase items using in-game currency (e.g., to unlock each of the aforementioned filters).

As shown in FIG. 5M, a final modified image 450 is displayed along with a keyword entry box 452, where the label for the final modified image corresponding to the original image is entered. In this case, the first user has taken a picture of his cat Mugsy, and enters ‘Mugsy’ in keyword entry box 452 (FIG. 5N). The first user may click the ‘send picture’ button 454 to send final modified image 450 to a second user (e.g., the user one selected via pushbutton 416A in FIG. 5B).

In FIG. 5O, the first user receives a success popup box 456 indicating that the game request has been successfully sent. In certain embodiments, a user can only play a game with another user who also signed up for the game. If one user has not signed up (e.g., registered), the registered user can send the unregistered user a text message invitation containing a link to download the app and sign up. In other embodiments, once a game request is sent to a second user device 120B, the second user may receive a text message, email, MMS, etc. from game server 102 with a link to download the game if he/she does not have it. If the second user has the game (e.g., it has been downloaded as an app), then the second user may receive a push notification. Upon opening the app on second user device 120B, the second user will see the game invite 458 (FIG. 5P). Upon selecting the ‘Accept’ push-button 460, final modified image 450 appears in split form in a user electronic display on second user device 120B (FIG. 5Q). The split form of the final modified image 450 includes modified image components 427A, 427B, 427C, and 427D just as they appeared before the first user created final modified image 450, visually delineated with vertical and horizontal borders 429A, 429B.

The user electronic display includes a timer display 462 of clock/timer 126 which begins to count down as soon as the second user accepts the game and the split form of the final modified image 450 is displayed for the second user. Here, sixty seconds are provided for the second user to solve the puzzle and guess its label. In certain embodiments, if the second user solves the puzzle (e.g. is able to transform the modified image components 427A, 427B, 427C, and 427D back to the original) before timer display 462 expires, then the second user may be declared a winner even if he cannot guess correctly. In other embodiments, if the second user is able to guess the label correctly, then he may be deemed the winner even if he is unable to create the original image before the timer expires. In yet other embodiments, solving the puzzle and imputing the correct label prior to expiration of the timer display 462 may be required to win the game. As shown, the second user has toggle 436 and can similarly switch between a flip frames mode and a switch frames mode, and use the same functionalities described above with respect to creation of the modified image, only to undo what was done to the image components.

As shown in FIG. 5R, the second user has correctly solved the puzzle by recreating the original image 426 from the modified image by correctly placing the image components 427A, 427B, 427C, and 427D in their correct locations with their correct rotative orientations. Additionally, the second user has done so in approximately twenty-eight seconds as timer display 462 still has thirty-two seconds left. In certain embodiments, the second user may be allowed to leave any primary or secondary filters placed on the image in place, and still be deemed to have solved the puzzle. In other embodiments, the second user may be allowed to use in-game items to remove the primary and secondary filters (or the changes thereto made by the first user), or to add extra time to timer display 462 to make solving the puzzle easier. Such in-game items may be provided for free or, in certain embodiments, may require a purchase from shop 404.

As shown in FIG. 5S, the second user is provided a guess box 464 where he/she can type and submit guesses as to the label for the original image. The guesses may appear in a list format 466 (FIG. 5T). If the second user correctly guesses the label (e.g., with an exact match or with a predetermined number of matching characters) before expiration of the timer, then he/she is notified that he/she won the game. If the second user does not correctly guess the label before expiration of the timer, then he/she may receive a popup box 468 (FIG. 5U) indicating he/she lost the game. The second user may receive a puzzle piece (e.g., a small amount of in-game currency or points) for shop 404 based on experience. The more times the user plays, the more experience and points he/she may acquire, which can allow the user to acquire free items (e.g, filter removal, timer extensions, etc.). The first user will also receive popup box 470 (FIG. 5V) indicating he/she stumped the second user.

As shown in FIG. 5W, the first user is given the list of guesses submitted by the second user, and given the option to award bonus points to the second user if the second user was close with his/her guesses. In this case, the second user guessed ‘cat’ and ‘kitten,’ so the first user may wish to award bonus points (or accept that the second user won the game) even though the name of the cat, ‘Mugsy’, was not guessed. Presumably, the second user would be a friend of the first user, and have heard the cat's name at some point. As shown in FIG. 5X, if the second user had guessed the label exactly prior to expiration of timer display 462, then both users would receive confirmation of the win, including popup box 472 on user device 120A of the first user. The users can then take new pictures and send new games to each other.

It will be appreciated that in certain embodiments, instead of the original image being split into four image components, it may be split into, for example, nine image components arranged in a three by three matrix instead of a two by two matrix, or into sixteen image components arranged in a four by four matrix, and so on. The system, methodologies, and functionalities described above may be used in such embodiments. For example, all nine or sixteen image components may be subject to modification by the user by rotating and/or moving the relative locations where they appear in the final modified image. It will be appreciated that the complexity and time needed to solve such a picture messaging puzzle will likely increase depending on the number of image components utilized.

In certain embodiments, a game request may be sent to multiple users simultaneously. In such scenarios, system 100 may be configured to allow for multiple winners, or to declare the first person who successfully cracks the puzzle before expiration of the timer the winner. In other embodiments, system 100 may be configured to await results from all invited participants, and if multiple participants crack the puzzle, declare the one who did it the fastest the winner. In certain embodiments, a piece of the modified image may be missing from the modified image sent to the second user, thus requiring the second user to solve the puzzle without it. In other embodiments, each image captured by a user (as well as the label the user enters for the image and guesses of users to whom the image is sent) may be stored in database 112 of game server 102 and categorized. Such information can be potentially useful for catering advertisements to particular users. In yet other embodiments, users may be allowed to rate one another through votes and comments.

In other embodiments, system 100 may be configured to provide “hangman” logic for guessing using the classic hangman guessing game where the word or phrase to be guessed is represented by a row of dashes representing each letter of each word. If a user player suggests a letter which occurs in the word, then the user can see it written on a display of his or her mobile device in all correct positions. If the suggested letter does not occur in the word, then the system may display a first or additional element of a hanged man stick figure for the user. If the other makes enough incorrect guesses, the system can decide that the game is over, and that the participating user has lost.

In certain embodiments, a ‘guess’ may be construed as either rotating a piece, switching a piece's location with another piece, or guessing a letter of the label. A finite, predetermined number of guesses may be allowed per game depending on the length of the word or phrase of the label. If a user guesses a word or letter incorrectly, than System 100 may be configured to utilize logic which calculates a minimum number of “guesses” needed given a label's word length and the number of different possible picture piece combinations. From this minimum number of guesses, system 100 may further calculate guess ranges associated with various levels competitiveness and ease of use for a given game. In certain embodiments, a randomize feature may be provided which sorts through which filters are unlocked by the user and randomly chooses a combination of picture pieces and filters.

It will be appreciated that various methodologies described herein may alternatively be utilized to generate and use a security key as described above with respect to the methodology of Steps 220-230 and 270-290 of FIG. 3. Additionally, portions of the gamified picture messaging described herein may be used in conjunction with social media platforms, social networking servers 104, and advertising. By way of example, a modified image may be displayed on a webpage, and require a website visitor to create the original image in order to access the full website, with or without a timer. Such challenges naturally make people curious, and depending on the puzzle complexity, may also get them emotionally invested. In certain embodiments, solving the puzzle may entitle a user to a coupon for a particular product or service. By gamifying picture messaging and advertising in this manner, the present invention can improve upon traditional advertising methods by getting a user to stay on a webpage while he/she tries to solve the puzzle, and by providing a new interactive way to advertise products and services.

It will be appreciated that other exemplary system architectures, functions, data storage and communication with game participants and APIs, as well as other exemplary methodologies for user registration, communication, and protocols, such as those disclosed in the Appendix of U.S. Provisional Patent Application No. 62/748,521, which is incorporated by reference herein in its entirety, may be utilized in accordance with exemplary embodiments of the inventive disclosure described herein. By way of example, technologies used for android in-app purchases may include Ionic Framework v1.3.3, Cordova Framework 8.0.0, and Cordova-plugin-inapppurchase to purchase consumables defined on both Android and IOS platforms and used for items offered from within the applications described herein. Examples of such items and uses may include, for example, puzzle pieces and removing ads and filters offered from within the application. The native Cordova plugin may be added before using this functionality.

By way of another example, images may be recorded using the Cordova Camera plugin and converted to a base 64 string. In order to manipulate the image into image components, four canvas elements may be created. In html5, a canvas element may be used as a container for graphics such as images. Each of the canvases may be given a two dimensional context using a canvas.getContext(‘2d’) method, and given a width and height of half of the original image. Once loaded, the original image may be scanned and drawn accordingly to each of the 4 canvases. Using the drawImage method, the original image may be scanned into four equal parts with each drawn onto a canvas element.

Once a user is finished manipulating individual canvases, he/she may reconstruct them into one coherent image. The canvas may be given the width and height of the original image, with negligible pixel loss. The drawImage method may be run four different times onto the context of this final canvas. Once drawn onto the final canvas, the image is converted into a base64 url string for later reference and use.

A In certain embodiments, a request to change data on the server side may be made. In order to do so, the client side request may first go through a checkpoint via a Heroku API. Once the proper parameters are met, the API can successfully make the change within a Firebase database and the update represented via the client side accordingly. In certain embodiments, a request to access or change data on the server side may also be made. The request from the client side may bypass the usual Heroku API and access the Firebase database directly. Data may then be sent back to the client side.

During sign-in, a user's email and password may be authenticated directly from the Firebase. If incorrect, the system may display an error message to the user on the user's mobile device. If correct, a secondary call may be made to the Heroku API, which obtains the user's information needed for different aspects of the game, returns the information back to the client, and saves it in local storage. The user may be then deemed successfully signed into a main game page of the application. During sign-up, system may call communicate with the Heroku API, which checks whether the username, email, and/or combination of phone number/country have already been taken. If so, an error message may be communicated to the user's mobile device (or PC). If all information is deemed new, then the API may create a new node within the database representing the user's profile/information. A response may be sent back to client side signaling the application to automatically sign the user into the main game page.

In certain embodiments of the game, watchers may be set in place which check for changes in specific data associated with a user. Information watched may include, for example, requests sent or received, bonus points requested or received, experience, current level, items, and PuzzlePieces (in-game currency). The client side may make a request to check whether information in the local storage matches the values of the information being watched in the database. If they are different, then the functionality may default to the values in the database. When the data is changed, the client side may be informed and updated accordingly.

When a user sends a game request to another user, the action may be documented within the database until the receiving user either accepts or declines the game request. With regard to the user who sent the game request, a “requests sent” section of that user's profile in the database may be updated and watched via a database watcher. The time elapsed since the user's request was sent may also be displayed to that user, i.e, a few seconds ago, 5 minutes ago, 3 hours ago, 2 days ago, etc. When a user sends a game request to another user, the action may also be documented within the database profile of the receiving user, such as a “requests received” section. This information may be watched and displayed accordingly to the client side via a database watcher. The receiving user may also have the option to either accept or decline the request. If the user declines the request, then the request may be removed from the “requests received” section of the receiving user in the database and the “requests sent” section of the sending user in the database, and displayed accordingly to both client side applications. If a user accepts a game request, then the user may be transferred to the gameplay page, and the request may be removed from both “requestsreceived” and “requests sent” sections.

As explained herein, when a game request is accepted, the receiving (participating) user tries to decrypt the sending user's image. If the receiving user runs out of time without guessing the title of the image, he/she may lose, and a bonus points request may be sent to the sending user. The watcher on the bonus points requests section picks up on the new request and displays it accordingly on the client side to the sending user. The request may display the words the receiving user guessed, and if the sending user chooses to accept, he/she can give bonus points to the receiving user. Such bonus points may be in the form of additional PuzzlePieces (currency) and experience. When a user accepts a bonus points request, multiple calls may be made to the API, which can in turn manipulate the database. First, a bonus points request may be removed from the user's section in the database. Second, a bonus points received request may be added to the receiving user's section in the database. Due to the watcher on this section, the user may receive an instant notification that he/she received bonus points. Once confirmed, the request may be automatically deleted from the database.

A user's experience level may be determined through the user winning games, losing games, and/or receipt of bonus points. Each time this occurs, the user's data may be updated via an API call, and displayed dynamically as the watcher may keep track of any changed data associated with the user. In certain embodiments, a user's “level” may represent accumulated experience. Once a user achieves/earns a predetermined number of experience points, a new level may be assigned. Each time this occurs, the data may be updated via an API call and displayed dynamically.

Various items and puzzle pieces may be used during different parts of a game, some permanent and others for one-time use. Items may be obtained via achievement of a particular level or purchase in the an on-line store associated with the game or mobile app. In addition to allowing purchase of in-game items, an on-line store associated with the game may also allow users to purchase different bundles of PuzzlePieces using real world currency. When a PuzzlePiece bundle is purchased successfully, an API call may be made, which updates the new amount of PuzzlePieces stored in the user's section in the database.

Database 112 may store each user's friends or friends list in case a user desires to play the game using another person's phone. While another person's phone would not contain the user's friend list in local storage, system 100 can simply check with the list in database 112 or the database of an API following the user's sign-in. Friend lists may be generated by manual input and/or by dynamic population of the list via contacts in the user's phone. Each time a user's friends list is updated on the client side, an API call may be made to update the list in the database as well.

System 100 may employ logic to check whether or not a friend has joined. If so, then a user can send the friend a game request. If not, then the user may invite the friend via SMS, MMS, email, etc. with a generic message and a link to the game in the app store. It will be appreciated that systems and methodologies disclosed herein may be used to take a picture of anything, decrypt it using a combination of in-game logic and in-game items, and send it to a friend with a keyword. If the friend can guess the keyword within the time limit (or within other constraints, such as the number of guesses of letters, words, or sentences), then he/she wins the game. If a user wins, multiple API calls are made. The user's experience and/or PuzzlePieces may go up a considerable amount. Additionally, an update may be sent to the friend's section in the database designating that they lost. Regardless of the outcome, the original encrypted image may or may not be deleted from the database's image storage afterwards depending on system configuration and/or user preference.

The described embodiments of the inventive disclosure are intended to be exemplary, and numerous variations and modifications will be apparent to those skilled in the art. All such variations and modifications are intended to be within the scope of the inventive disclosure as defined in the appended claims. Although the present invention has been described and illustrated in detail, it is to be clearly understood that the same is by way of illustration and example only, and is not to be taken by way of limitation. It will be appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that particular embodiments described in the specification are intended only to provide a detailed disclosure of the present invention, and are not intended to be limiting. Modifications of the above disclosed apparatuses and methods which fall within the scope of the invention will be readily apparent to those of ordinary skill in the art. Accordingly, while the present invention has been disclosed in connection with exemplary embodiments thereof, it should be understood that other embodiments may fall within the spirit and scope of the invention, as defined by the following claims.

What is claimed is:

1. A system for playing a picture messaging game, comprising:
a game server operatively coupled, via a network, to one or more computing devices, the game server including a database for storing user data and game data, and at least one non-transitory computer-readable storage medium having computer-readable instructions stored therein to remotely perform the game; and at least one processor configured to execute the computer-readable instructions to:
receive an original image;
generate a modified image based on the original image and one or more inputs to a first computing device associated with a first user;
transmit a game request and the modified image to a second computing device associated with a second user;
display the modified image on the second computing device; and
prompt the second user, via the second computing device, to at least one of;
(i) input a guess as to the original image; or
(ii) transform the modified image into the original image.

2. The system of claim 1, wherein the at least one processor is further configured to execute the computer-readable instructions to:
split the original image into a plurality of original image components;
display the plurality of original image components in a first electronic user interface on the first computing device;
receive, through the first electronic user interface, one or more inputs associated with one or more of the plurality of original image components; and
generate one or more modified image components from the plurality of original image components by altering, based on the one or more inputs received through the first electronic user interface, at least one of:
(a) an orientation of one or more of the original image components;
(b) a relative location of at least two of the original image components; or
(c) a filtering level of a color, a shade, a hue, or a color intensity of one or more of the original image components.

3. The system of claim 2, wherein the plurality of original image components include four image components arranged in a two by two matrix.

4. The system of claim 2, wherein the at least one processor is further configured to execute the computer-readable instructions to:
generate the modified image using at least the one or more modified image components.

5. The system of claim 2, wherein the at least one processor is further configured to execute the computer-readable instructions to:
display the modified image in a second electronic user interface on the second computing device, wherein the modified image is displayed either assembled or split with the modified image components and any unmodified original image components visually delineated.

6. The system of claim 2, wherein each image component has one of a height and a width larger than the other of the height and the width.

7. The system of claim 2, wherein the at least one processor is further configured to execute the computer-readable instructions to:
generate a first modified image component by altering the orientation of a first original image component by rotating the first original image component.

8. The system of claim 2, wherein the at least one processor is further configured to execute the computer-readable instructions to:
generate second and third modified image components by altering relative locations of second and third original image components by swapping respective locations of the second and third original image components.

9. The system of claim 2, wherein the at least one processor is further configured to execute the computer-readable instructions to:
split the original image along a vertical axis and along a horizontal axis such that the original image components are offset from one another and symmetrically arranged about a center point of the original image.

10. The system of claim 2, wherein the at least one processor is further configured to execute the computer-readable instructions to:
display, within the first electronic user interface, a toggle configurable by the first user to a flip frames mode and a switch frames mode;
upon selection of the flip frames mode, enable the first user to change a rotational orientation of one or more image components; and
upon selection of the switch frames mode, enable the first user to switch a respective location of one or more image components,
wherein the toggle is repeatedly switchable to the flip frames mode and the switch frames mode such that the first user can repeatedly change the rotational orientation and the respective location of each image component.

11. The system of claim 1, wherein the at least one processor is further configured to execute the computer-readable instructions to:
input, via the first computing device, a label associated with the original image;
store the label and the original image in a database; and
compare at least one of:
(i) a guess inputted via the second computing device to the label, or
(ii) a transformed modified image to the original image.

12. The system of claim 11, wherein the at least one processor is further configured to execute the computer-readable instructions to:
responsive to the guess being inputted prior to an expiration of a predetermined time period and matching the label, determining the second user a winner of the picture messaging game;
responsive to the guess not being inputted prior to the expiration of the predetermined time period, determining the second user a loser of the picture messaging game, and displaying, to the first user via the first computing device and the second user via the second computing device, a result of the game.

13. The system of claim 11, wherein the at least one processor is further configured to execute the computer-readable instructions to:
responsive to the guess being inputted prior to the expiration and not matching the label, transmitting the guess to the first computing device, displaying the guess to the first user, and prompting the first user to input whether the guess is sufficiently close to the label to determine the second user a winner.

14. The system of claim 1, wherein the at least one processor is further configured to execute the computer-readable instructions to:
receive, from the second user through a second electronic user interface on the second computing device, one or more inputs associated with the modified image; and
altering, based on the one or more inputs received through the second electronic user interface, at least one of
(i) an orientation of one or more image components of the modified image;
(ii) a relative location of at least two image components of the modified image; or
(iii) a filtering level of a color, a shade, a hue, or a color intensity of one or more image components of the modified image.

15. The system of claim 1, wherein the at least one processor is further configured to execute the computer-readable instructions to:
capture a new original image using a camera of the second computing device associated with the second user;
split the new original image into a plurality of new original image components;
display the plurality of new original image components in a new electronic user interface on the second computing device;
receive, through the new electronic user interface, one or more inputs associated with one or more of the plurality of new original image components;
generate one or more new modified image components from the plurality of new original image components based on the one or more inputs received through the new electronic user interface;
generate a new modified image using at least the one or more new modified image components; and
transmit a new game request and the new modified image from the second computing device to either the first computing device associated with the first user or another computing device associated with another user.

16. The system of claim 1, wherein the at least one processor is further configured to execute the computer-readable instructions to:
capture the original image using a camera of the first computing device associated with the first user.

17. A computer-implemented system for establishing a security key, the system comprising at least one processor configured to:
obtain an original image from a user;
split the image into a plurality of original image components;
display the plurality of original image components in a first electronic user interface on a first computing device associated with the user;
receive, through the first electronic user interface, one or more inputs associated with one or more of the plurality of original image components;
generate one or more modified image components from the plurality of original image components by altering one or more of the original image components based on the one or more inputs received through the first electronic user interface; and
generate a security key for the user based on at least one of the modified image components or the one or more inputs.

18. The system according to claim 17, wherein the at least one processor is further configured to:
display the security key to the user in the form of the one or more modified image components;
receive one or more security inputs from the user via the first computing device which modify the one or more modified image components into the original image components;
responsive to modification of the one or more modified image components into the original image components within a predetermined time-frame, allow the user access to a website or a device.

19. The system according to claim 17, wherein the one or more security inputs correspond to a particular sequence to modify the modified image components into the original image components, and access to the website or device requires following the particular sequence.

20. The system according to claim 19, wherein the at least one processor is further configured to train the user to follow the particular sequence within a predetermined time frame.
